(19) United States
(12) Patent Application Publication
(10) Pub. No.: US 2014/0060211 A1
(43) Pub. Date: Mar. 6, 2014

(54) DEVICE FOR MEASURING PHYSICAL CHARACTERISTICS AND/OR CHANGES IN PHYSICAL CHARACTERISTICS IN A SHEET

(71) Applicant: Bram Van den Broeck, Borgerhout (BE)

(72) Inventor: Bram Van den Broeck, Borgerhout (BE)

(21) Appl. No.: 14/027,466

(22) Filed: Sep. 16, 2013

Related U.S. Application Data
(63) Continuation of application No. PCT/BE2012/000013, filed on Mar. 13, 2012.
(60) Provisional application No. 61/452,924, filed on Mar. 15, 2011.

(30) Foreign Application Priority Data
May 10, 2011 (BE) 2011/0285

(51) Int. Cl. G01L 1/16

(52) U.S. Cl. CPC G01L 1/16
USPC 73/862.68

(57) ABSTRACT

Device (1) for measuring physical characteristics or changes in physical characteristics in a sheet (2), provided with one or more sensors (3) embedded in the sheet (2), whereby the sensors (3) are meant to measure at least one of the aforementioned physical characteristics and generate or influence an electrical signal (8) as a function of a measured physical characteristic or a change in such a physical characteristic, whereby the device (1) also includes a signal processing unit (9) for processing the electrical signal (8) or the electrical signals (8) supplied to the signal processing unit (9) from the sensor (3) or the sensors (3).

### CROSS REFERENCE RELATED APPLICATIONS

This application is a continuation of International Application No. PCT/BE2012/000013 filed Mar. 13, 2012; which claimed priority to Provisional Application No. 61/452,924 filed Mar. 15, 2011 and Belgium Application No. 2011/0285 filed May 10, 2011, respectively. The entire contents of each of the above-identified applications are hereby incorporated by reference.

### FIELD OF THE INVENTION

The present invention relates to a device for measuring physical characteristics, and/or changes in physical characteristics in a substrate sheet or foil material.

The physical characteristics to be measured could be e.g. a static or dynamic tension distribution in the sheet, an elongation in the sheet, a vibration frequency in the sheet and/or one or more physical characteristics of any kind.

### BACKGROUND OF THE INVENTION

A typical application of such a measuring device according to the invention will be for example the measuring of a tension distribution in a percussion instrument head, made for example of a Mylar (PET) film, or the like, with this device.

Such a percussion instrument head may be the head of a drum, conga, bongo or any other head of a percussion instrument.

Also heads of other instruments, for example of a banjo, are not excluded from the invention.

Some devices for measuring physical characteristics of a sheet material and specifically of a percussion instrument head already exist.

For example, in a known device for measuring physical characteristics on a drum head a piezoelectric sensor is placed on or glued onto the drum skin, whether or not in an integrated manner.

### SUMMARY OF THE INVENTION

This piezoelectric sensor usually produces an electrical signal as a function of a measured pressure or a change in pressure, acceleration or force.

Typically in the known devices, the aim is to detect with the aforementioned piezoelectric sensor when the drum head is struck by a drum stick.

This way of detection is also known as triggering.

In that case an electrical signal is generated by the piezoelectric sensor and this electrical signal is supplied to an electronic controller, for example for producing all kinds of sounds chosen by the user.

However, the known electrical devices for measuring physical characteristics in a head have rather limited possibilities.

First of all, the possibilities for measuring physical characteristics are limited by the type of sensor used.

Furthermore, it is for example impossible to measure a tension distribution in a head with the known electrical devices or methods.

With the known electrical devices it is also impossible to detect the exact position where the drum stick has struck the drum head.

Moreover, the possibilities of the electronic controllers for processing an electrical signal from the sensor on the head, are very limited with the known devices and methods.

The present invention therefore aims to provide a solution for one or more of the aforementioned and/or other possible disadvantages.

The present invention aims to provide an improved device for measuring physical characteristics or changes in physical characteristics in a head, which offers at least many more possibilities than the known devices to this end.

To this aim, the invention relates to a device for measuring physical characteristics or changes in physical characteristics in a sheet material, said device comprising at least one sensor that is not a piezoelectric sensor or multiple sensors of any type, said sensor or sensors being provided on or suitable for being provided on a sheet material and meant for measuring at least one of the physical characteristics mentioned above, whereby the sensor generates or influences an electrical signal or the multiple sensors generate or influence an electrical signal, as a function of the measured physical characteristic or change in such a physical characteristic, whereby the device also comprises a signal processing unit for processing the electrical signal or electrical signals supplied to the signal processing unit from the sensor or sensors.

A first important advantage of such a device for the measuring of physical characteristics or changes in physical characteristics in a sheet material according to the invention is that by choosing a sensor which is not a piezoelectric sensor or by choosing multiple sensors of any type, another physical characteristic or other physical characteristics or changes in said other physical characteristic or characteristics can be measured than with the known devices and methods provided with a single piezoelectric sensor.

Measurement of said other physical characteristic or other physical characteristics or changes in said other physical characteristic or characteristics, allows for the development of new applications.

In a preferred embodiment of a device according to the invention, said device comprises multiple sensors, which are for example embedded in a multitude of positions in the sheet and/or can be for example of the same or of different types.

An important advantage of such an embodiment of a device according to the invention is that it is possible to obtain a more realistic image of the actual state of the sheet, in static as well as in dynamic conditions, by taking into account multiple measurements.

Also, variations in the surface of the sheet can be taken into account.

In that way, such a measuring device paves the way for multiple new applications.

For example, by measuring the intensity of tension and/or tension distribution in e.g. a drum head, an indication which can be used for tuning the drum head can be obtained.

Such an indication to tune the drum head can for example be produced, based on a measurement of the intensity or the distribution of a tension in the drum head and can for example be an indication as to where the tension in the drum head should be increased or decreased, for example by tightening or loosening one or more of the drum head's tensioning bolts.

In such an application, the signal processing unit is preferably conceived as a device for tuning the drum head or the signal processing unit provides an output signal which can serve as in input signal for a tuning device.

In another application the measurement of a tension distribution in the head over time or the detection of the position of an impact on the head can be linked to sound files stored in a database.

The invention also relates to a sheet material which is adapted for the use of said device according to the invention for measuring physical characteristics or changes in physical characteristics in the sheet material.

Such a head or a sheet material according to the invention, is provided with multiple sensors which are embedded in the sheet to measure at least one or more physical characteristics or changes in physical characteristics in the sheet, whereby the sensors are suitable to generate or influence an electrical signal as a function of a measured physical characteristic or change in physical characteristic and in addition, the sheet material is provided with at least one connector to connect it with a signal processing unit meant for processing signals which are supplied to the signal processing unit from the sensors.

It is obvious that such a sheet material, which has been provided with multiple sensors which supply electrical signals to a signal processing unit via at least one connector on the sheet, is highly suitable for the aforementioned applications and other applications.

### BRIEF DESCRIPTION OF THE DRAWINGS

With the intention of better showing the characteristics of the invention, hereafter, as an example without any restrictive character whatsoever, some possible preferable embodiments of devices and sheets, according to the invention are represented with reference to the accompanying figures, wherein:

FIG. 1 schematically represents a first embodiment of a device according to the invention provided with a single sensor;

FIG. 2 schematically represents another embodiment of a device according to the invention provided with multiple sensors;

FIG. 3 represents a perspective view of a drum head, according to the invention and intended to be used according to the invention, with 8 embedded sensors;

FIG. 4 represents a more detailed top view on the part of FIG. 3 indicated as F4;

FIG. 5 represents a cross-section along the line ‘V-V’ in FIG. 4 through a possible embodiment of a sheet according to the invention and comprised of multiple layers;

FIGS. 6 to 8 schematically represent a top view on circular sheets according to the invention, each sheet being provided with ten sensors at regular distances in relation to each other near a circle at the outer edge of the circular sheet, and the sheets being respectively outfitted with 6, 8 and 10 bolts for tensioning the sheet;

FIGS. 9 tot 11 show how a circular sheet according to the invention can be divided in fields, using a combination of radial and concentric fields; and,

FIGS. 12 tot 21 schematically illustrate different modes a head can be struck.

### DETAILED DESCRIPTION OF THE INVENTION

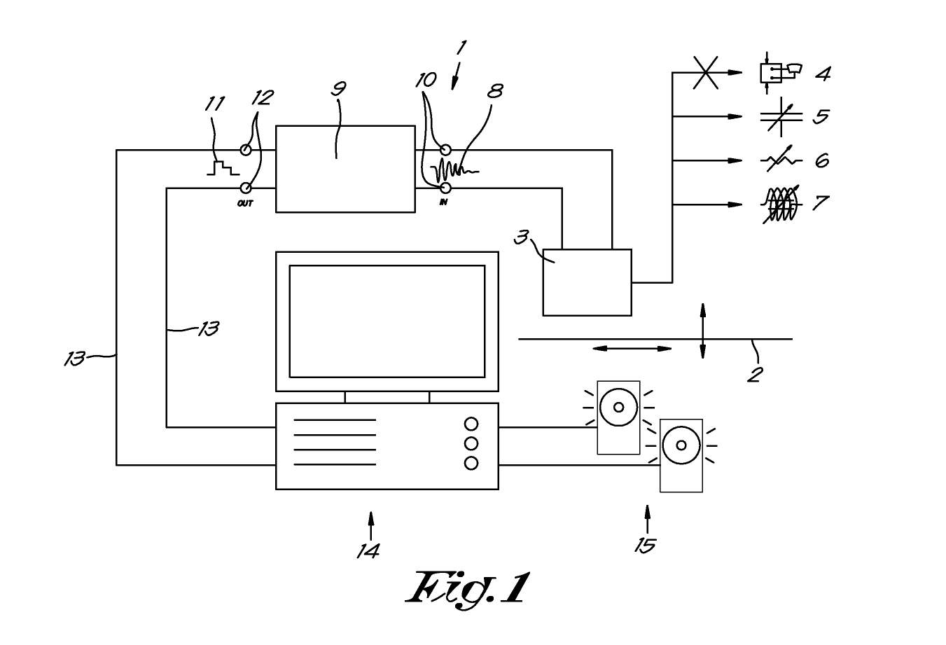

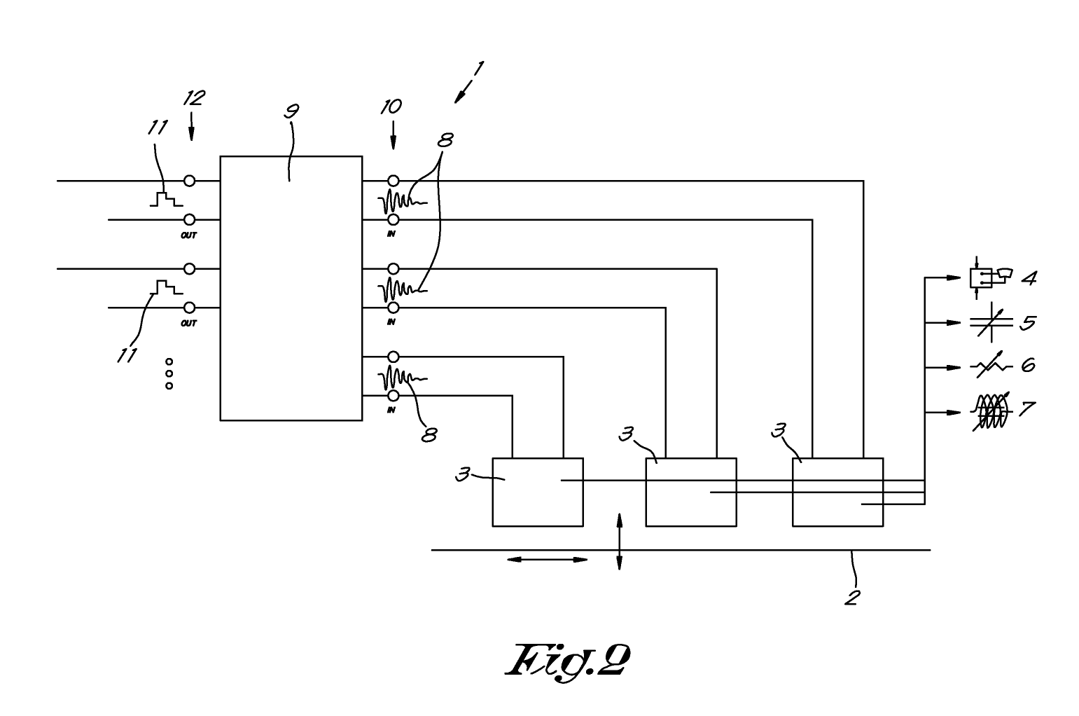

The device according to the invention as represented in FIG. 1 is meant for measuring physical characteristics or changes in physical characteristics in a sheet 2, for example a movement of the sheet 2, a tension change in sheet 2 or an elongation in sheet 2, or the like, as is symbolically represented by the arrows in FIG. 1 by sheet 2.

In the embodiment in FIG. 1 of a device 1 according to the invention, the device has a single sensor 3, of a variable type, but whereby sensor 3 is not a piezoelectric sensor 4.

The sensor 3 can be for example a capacitive sensor 5, a resistive sensor 6 or an inductive sensor 7, but other kinds of sensors 3 for measuring a physical characteristic or a condition of the sheet 2 are by no means excluded.

A summary of different possible kinds of sensors 3 for applications in a device 1 according to the invention with a single sensor 3 is represented by way of illustration in the right hand part of FIG. 1.

Obviously, sensor 3 needs to be suitable for measuring the physical characteristic or the condition of the sheet 2 to be measured and therefore has to be provided on the sheet 2 or needs to be suitable to be provided on a sheet 2.

Sensor 3 should generate or influence an electrical signal 8 as a function of such a physical characteristic or a change in such a physical characteristic of the sheet 2.

For example, when using a capacitive sensor 5, the first of the capacitor plates can be applied to the top surface of the sheet 2 or to a first sheet layer ((or ply)) of sheet 2 and another capacitor plate can be applied to the bottom surface of the sheet 2 or to another sheet layer (or ply) of sheet 2, so that a vibration of sheet 2 corresponds to a relative movement of the capacitor plates in relation to each other following a local change in thickness of the sheet 2 or following a change in the distance between sheet layers (or plies) of the sheet 2, leading to a measurable change in capacity.

In a similar way, an inductive sensor 7 can be applied according to known techniques, in which case the measured physical characteristic preferably has an effect on the inductive sensor 7, for example because a change of the physical characteristic generates a change in the reluctance of the inductive circuit (for example through a change in the size of an air gap in the inductive circuit), generates eddy currents or generates a voltage by movement in a magnetic field (Hall effect) or the like.

Measurement of an elongation in the sheet 2 can for example be done by gluing or applying a resistive sensor 6 on the sheet 2, whereby a transformation of the sheet 2 generates a transformation and therefore a change in the resistance of the resistive sensor 6.

This is one of the possible ways of measuring the local elongation of the sheet 2 at the position of sensor 3 under the influence of a tension in the sheet 2, but other possibilities are by no means excluded.

Furthermore, the device 1 according to the invention comprises a signal processing unit 9 for processing the electrical signal 8, supplied at an input 10 of the signal processing unit 9 from the sensor 3.

Such a signal processing unit 9 can for example mainly consist of an electronic circuit, or the like, in which the electrical signal 8 of the sensor 3, typically an input voltage 8, is converted at the input 10 of the signal processing unit 9 into an electrical signal 11, typically an output voltage 11, at an output 12 of the signal processing unit 9.

In the shown example, the electrical signal 11 at the output 12 of the signal processing unit 9 is supplied via a cabling 13 to a computer 14, to which a sound system 15 is connected.

The computer 14 can for example be equipped with software to further process the electrical signal 11 of the signal processing unit 9, for example to generate a certain graphic output or to play a certain digitally stored sound file through the sound system 15, as a function of the electrical signal 11.

Obviously, many other embodiments are not excluded.

For example, the signal processing unit 9 can be an integral part of the computer 14 and can for example simply be realized with especially adapted software.

Also, the signal processing unit 9 can for example in itself be conceived as an appliance giving direct indications to the user, for example by means of a display, or e.g. LEDs which directly indicate a readout of the measured physical quantity or for example via a sound signal or the like, all for the purpose of giving indications concerning the tuning of a sheet 2 or the like.

This most essential embodiment of a device 1 according to the invention, as shown in FIG. 1, already provides a substantial advantage in comparison with known devices because a sensor 3 which is best suited to the measured physical quantity is applied.

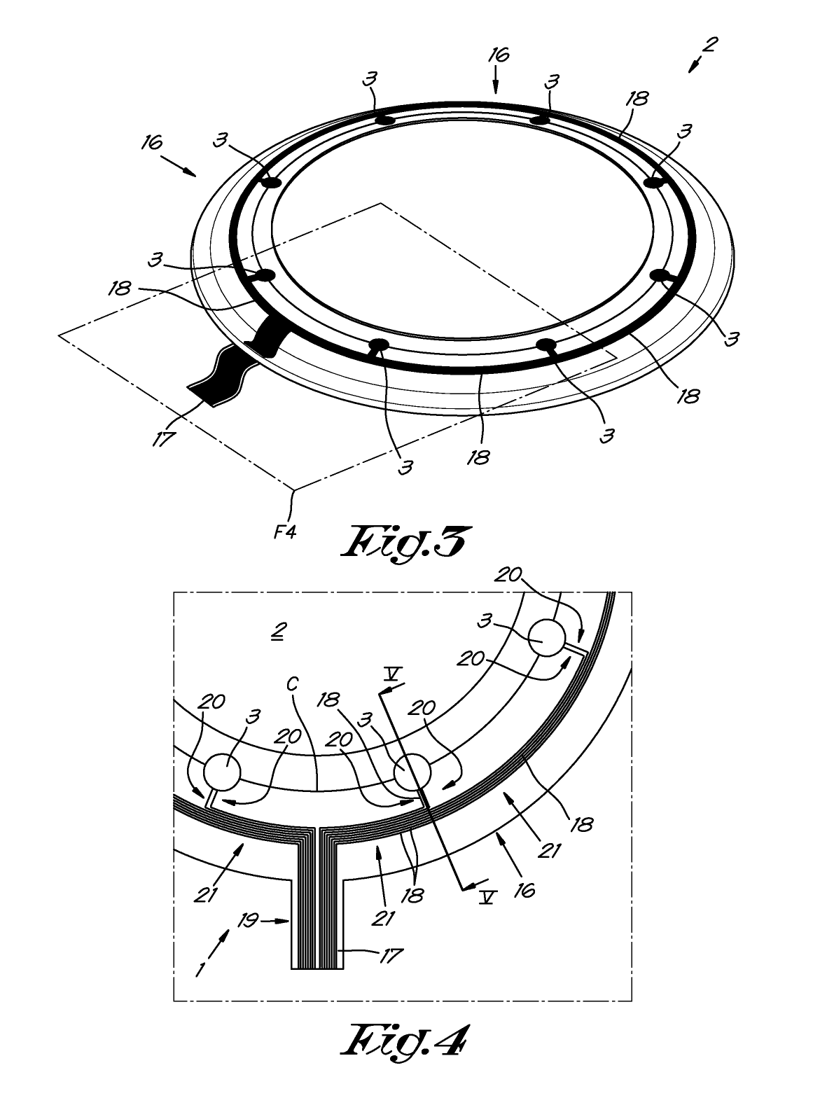

According to a more preferred embodiment of a device 1 according to the invention, as schematically represented in FIG. 2, multiple sensors 3 of any type, be it of the same type or of a combination of different types of sensors 3, are applied.

For example, one or more piezoelectric sensors 4 can be embedded, whether or not it be in combination with one or more capacitive sensors 5, resistive sensors 6 or inductive sensors 7 etc., as again is represented as an illustration in the right hand part of FIG. 2.

The multiple sensors 3 all generate or influence an electrical signal 8 as a function of one or other physical characteristic in the sheet 2, as for example a movement of the sheet 2 at a certain position or a change in tension or an elongation at a certain position in the sheet 2 and the like.

In which case, as in the shown embodiment in FIG. 2, the sensors 3 are all connected with one or multiple inputs 10 of a signal processing unit 9, whereby the given electrical signals 8 are converted in the signal processing unit 9 into one or more electrical signals 11 in one or multiple outputs 12 in the signal processing unit 9.

A device 1 according to the invention is preferably conceived so that an electrical signal 8 or a combination of multiple electrical signals 8, generated or influenced by the sensors 3, provides or provide a measure for at least one of the following characteristics:
an elongation of the sheet 2,
a static tension distribution over the sheet 2,
a dynamic tension distribution over the sheet 2,
a tension change in the sheet 2 or a frequency change in the sheet 2,
a position in the sheet 2 of a tension change,
a distribution of a tension change in the sheet 2, and/or
a vibration frequency in the sheet 2.

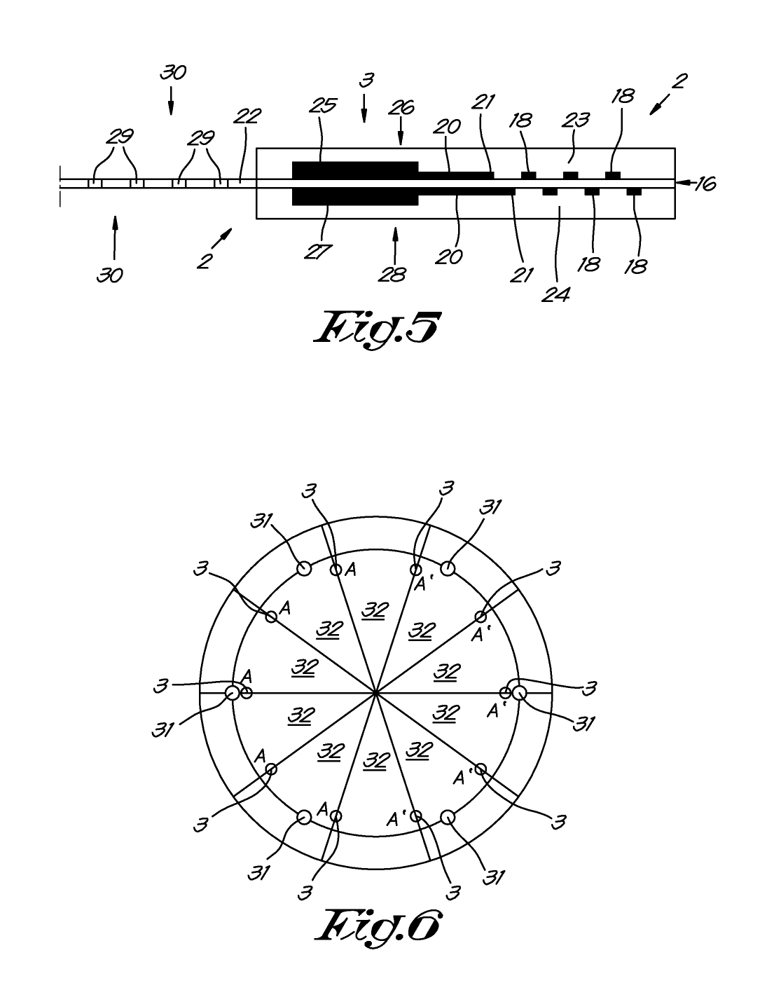

FIG. 3 represents a perspective view of a sheet 2 according to the invention, which is entirely adapted for the use in a device according to the invention, as described before and as schematically represented in FIGS. 1 and 2.

The sheet 2 according to the embodiment in FIG. 3 is a circular membrane of the head 2 of a percussion instrument provided with multiple sensors 3, in the given case eight sensors 3, embedded in the sheet 2 with the purpose of measuring at least one or multiple physical characteristics or changes in physical characteristics in the sheet 2.

The sensors 3 and, extensively, also the sheet 2, are conceived as a part of a device 1 according to the invention.

The sensors 3 are placed at regular intervals in relation to each other on a circle C, near the outer edge 16 of the circular sheet 2.

The sheet 2 further comprises a connector 17 to connect the sheet 2 with a signal processing unit 9 of a device 1 according to the invention, as described before, whereby this signal processing unit is meant to process electrical signals 8 that are supplied to the signal processing unit 9 from the sensors 3.

In this case, each sensor 3 is connected to a single connector 17, which is provided at a given position near the outer edge 16 in the sheet 2, whereby the connection between the sensors 3 and the connector 17 is realized by making use of electrically conductive material 18, which is applied onto the sheet 2 in the form of lines, strips or areas.

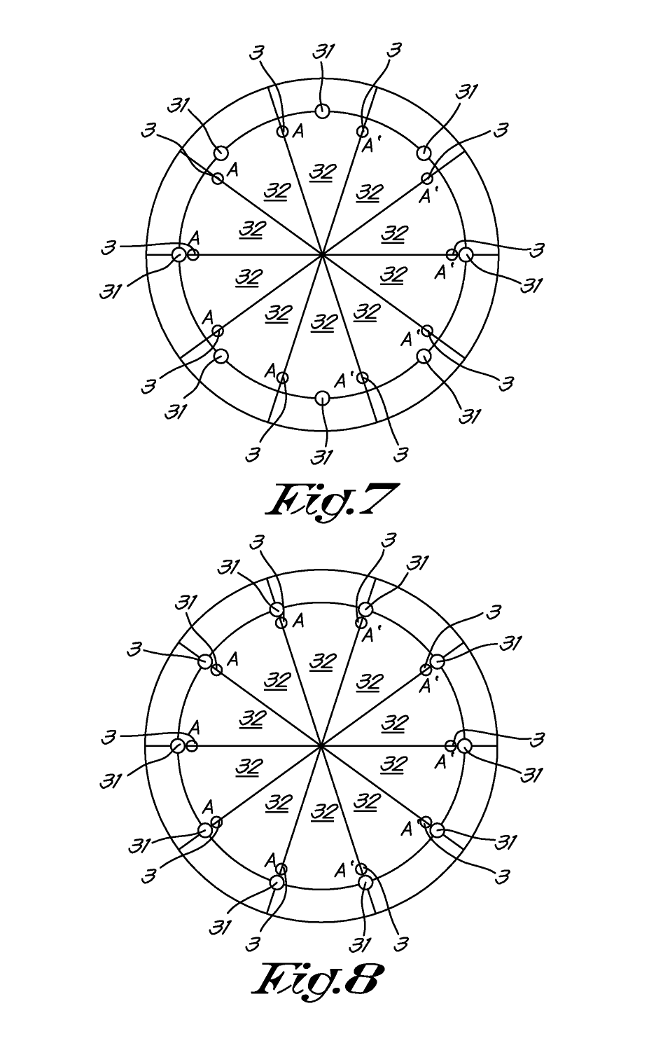

In the shown example in FIG. 3 (illustrated in further detail in FIG. 4), each connection between a sensor 3 on the sheet 2 and the connector 17 is realized by a pair of adjacent traces of electrically conductive material 18, of which a part 19 in the connector 17 stretches out of the sheet 2 in radial fields, of which a part 20 in the position of the regarded sensor 3 also stretches out in radial fields from the regarded sensor 3 and of which an intervening part 21 is applied concentrically near the outer edge 16 of the sheet 2.

To use the available space near the outer edge 16 of the sheet 2 as efficiently as possible, the concentric parts 21 of the traces of electrically conductive material 18 of the sensors 3 closest to the connector 17, are placed radially inwards on the sheet 2.

The concentric parts 21 of the traces of electrically conductive material 18 of the following sensors 3, are applied gradually and radially more outward, so that the concentric parts 21 of the traces of electrically conductive material 18 of consecutive sensors 3 can be close together and so that the radial parts 19 and 20 can continue until the connector 17 and to the regarding sensor 3 without having to cut the traces of electrically conductive material 18 of adjacent sensors 3.

Until now, when discussing the traces of conductive material 18, it has been implicitly assumed that the sheet 2 consists of a single sheet layer (or ply) and that the sensors are applied on one side of this sheet layer.

In this set up, the traces of conductive material 18 are separated from each other by a dielectric, for example an insulator layer, consisting of a polymer.

A capacitive sensor 5, applied to a single side of a single sheet layer, could consist of the following:
the sheet 2 as a substrate;
on which on one side, a first layer of electrically conductive material 18 is applied to form a first electrode of the sensor 5;
this first electrically conductive layer 18 is covered by a dielectric insulation layer that is formed by e.g. a polymer;
on which then a second layer of electrically conductive material 18 is applied.

According to the invention, this is not necessarily the case and it is perfectly possible to manufacture the sheet 2 with multiple sheet layers (or plies) and to embed sensors 3 in more than one side of a sheet layer of the sheet 2.

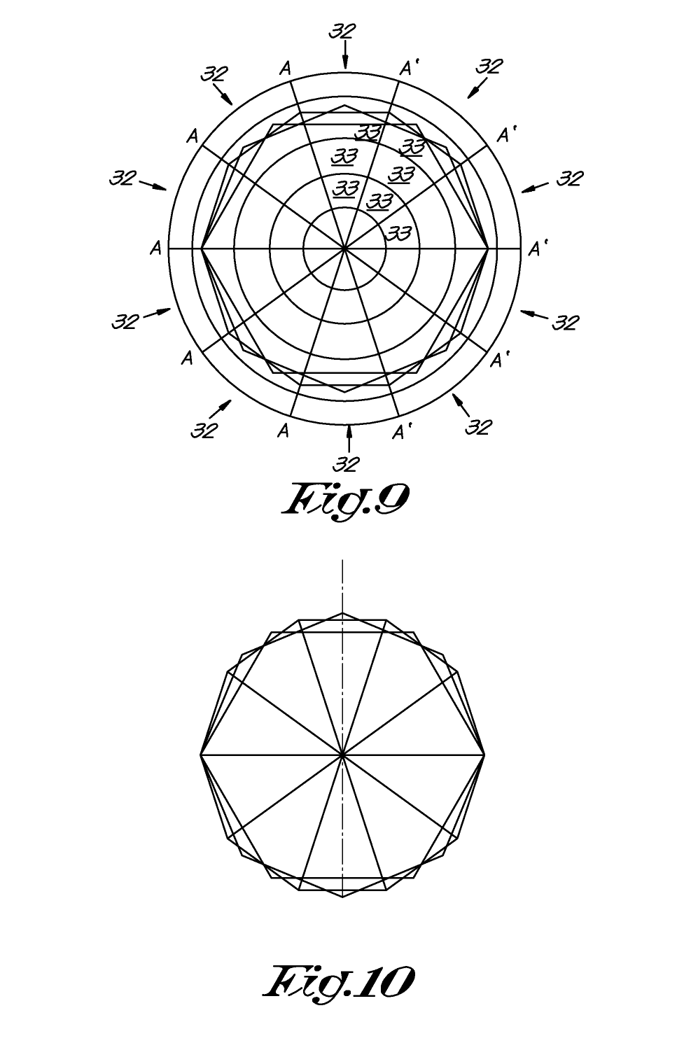

In the cross section in FIG. 5 such a sheet 2, made up of different sheet layers (or plies), is represented.

More specifically, the sheet 2 in the shown example consists of an intervening sheet layer (or ply) 22 which is provided with a top sheet layer (or ply) 23 and a bottom sheet layer (or ply) 24 near the outer edge 16 of the sheet 2.

In this case, the top sheet layer (or ply) 23 and the bottom sheet layer (or ply) 24 are formed by a circular strip so that when the sheet 2 is stretched onto a percussion instrument, during normal use, in this embodiment only the intervening sheet layer (or ply) 22 will be struck.

According to the invention, application of more or fewer sheet layers (or plies) that span all of the intervening and/or other sheet layers (or plies) is of course not excluded.

In the embodiment as shown in FIG. 5 of a sheet 2 according to the invention, each sensor 3 is conceived as a capacitive sensor 5, whereby each sensor 3 has an electrically conductive part 25 applied to a first side 26 of an intervening sheet layer (or ply) 22, as well as an electrically conductive part 27 which is applied to the other side 28 of the intervening sheet layer (or ply) 22.

These electrically conductive parts 25 and 27 of each sensor 3 are connected to the connector 17 of the sheet 2 via a trace of electrically conductive material 18.

The intervening sheet layer (or ply) 22 hereby forms a dielectric and therefore electrically insulating part that separates the two electrically conductive parts 25 and 27.

The top sheet layer (or ply) 23 and the bottom sheet layer (or ply) 24 are also made up of a dielectric and function as a protection of the sensor parts 25 and 27, as well as the traces of electrically conductive material 18.

In a similar way, other types of sensors 3 can of course be realized by applying one or more areas of electrically conductive material 18 onto the sheet 2 or on one or multiple sheet layers (or plies) of the sheet 2.

In this case, the sheet 2 is also partly provided with meshes, perforations, cutouts, apertures, holes 29 or, in other words, it is at least partly provided with a net shaped structure, meshed structure, perforated structure or woven structure or the like.

More specifically, the intervening sheet layer (or ply) 22 in the example in FIG. 5 is provided with such meshes, perforations, cutouts, holes or apertures 29 in the circular part which stretches out to the radial outer part with the sensors 3 and which is meant to be struck during the use of the sheet 2 in a percussion instrument.

The purpose of the holes or apertures 29 is to prevent or to limit as well as possible the production of sound or the movement of air caused by vibration as a typical consequence of striking the sheet 2 with e.g. a drum stick or the like.

In a possible application thereof the sensors 3 on the sheet 2 are used to play a sound file when a drum stick strikes the sheet 2, for example through headphones.

This way, it can be made possible for a percussionist to play percussion while no or a rather limited sound level is produced so that other people will not be disturbed while the percussionist can still perceive a sound through a set of headphones, comparable to the sound produced when playing a traditional percussion instrument.

Also, it is important to note that in the example in FIG. 5 the intervening sheet layer (or ply) 22 is partly provided with meshes, perforations, cutouts, apertures or holes 29 or of a net shaped structure, while sheet layers (or plies) 23 and 24 have no meshes, perforations, apertures or holes 29 or no net shaped structure, in as far as the central circular aperture 30 in sheet layers (or plies) 23 and 24 is not considered to be a mesh, perforation, cutout, aperture or hole 29.

Sensors 3 are then embedded between the part of intervening sheet layer (or ply) 22 showing no meshes, perforations, cutouts, apertures or holes 29 or which has no net shaped structure and such sheet layers (or plies) 23 and 24 that also do not have meshes, perforations, cutouts, apertures or holes 29, so that a good vibration transmission or transmission of the transformation of the regarded sheet layers (or plies) 22 to 24 is assured and the sheet layers (or plies) 23 and 24 are provided with a central circular aperture spanned by a meshed intervening sheet layer (or ply) 22, or a sheet layer (or ply) 22 with a net shaped structure or a sheet layer (or ply) 22 with perforations, apertures, holes or cutouts 29 to obtain a noiseless striking surface for a percussionist's drum stick.

Naturally, an embodiment as shown in the cross section of FIG. 5 is but one of many possibilities.

For example, the sheet 2 can very well consist of more or fewer sheet layers (or plies), whether or not provided with a circular aperture and/or net shaped structure.

Also, individual sensors 3 can be embedded in multiple layers of the sheet 2 by means of possibly partly overlapping areas of electrically conductive material 18, separated by a dielectric, and sensors 3 in relation to each other and traces of electrically conductive material 18 in relation to each other can be applied on several layers.

The sheet 2 or sheet layers (or plies) of the sheet 2 can function as a dielectric to separate traces, lines, strips or areas of electrically conductive material 18, but for such a separation materials that can function as a dielectric and which are especially applied for this purpose onto the sheet 2 or sheet layers (or plies) of the sheet 2 can also be used.

Furthermore, multiple sensors 3 on a sheet 2 can be configured otherwise than described before, for example by connecting sensors 3 to each other in series or parallel by traces, or the like, of electrically conductive material 18 applied to the sheet 2 or to one or multiple sheet layers (or plies) of the sheet 2.

According to a preferred embodiment of a sheet 2 according to the invention the sheet 2 is made of synthetic material.

According to a yet more preferred embodiment of a sheet 2 in accordance with the invention the sheet 2 is made of biaxially-oriented polyethylene terephthalate (boPET).

However, as an alternative and according to the invention, it is not excluded to make the sheet 2 of leather, as is common in percussion instruments, or of any other material suitable for the suggested application.

For the lines, strips, traces or areas of electrically conductive material 18, a metallic material for example can be used.

Another possibility is to manufacture the lines, strips, traces or areas of electrically conductive material 18, of an electrically conductive, organic, polymer material.

An electrically conductive, organic, polymer material that according to the invention is especially suited, is Poly(3,4-ethylenedioxythiophene)poly-cation, also known as PEDOT.

Naturally, other materials for manufacturing the electrically conductive material 18 are not excluded.

The pattern formed by the strips or areas of electrically conductive material 18 can for example be printed or ink-jet printed on the sheet 2, for example by using flexographic printing technique, offset printing technique, rotary screen printing technique or roll to roll printing, inkjet printing, or any other suitable printing technique.

An advantage to the use of printing techniques is that it creates the possibility of printing in an economical way and in large quantities.

By printing on a roll, the production cost can be minimized.

The used printing techniques need to be adapted so that they can realize electronic circuitry and are preferably optimized to this end.

In these printing techniques therefore, an especially adapted resolution and high precision or accuracy is applied and adapted printing inks are used, in order to obtain a finished product with the suitable electrical characteristics for the regarded application, for example in a percussion instrument head.

An advantage of the application of a flexographic printing method is that this printing method comprises a high pressure printing process which is very suitable for printing on synthetic substrates.

An offset printing method is a flat (planographic) printing method that allows a high resolution.

An engraving printing method is a low pressure printing method, whereby organic dissolvents can be used and which is suitable for the production of large quantities.

Rotary screen printing is a printing method that allows printing in relatively thick layers.

Additionally, there are so called coating methods, which is a generic name for a diversity of methods whereby homogeneous and thin covering layers can be applied to a substrate.

With this alternative method strips, traces, lines or areas can be coated on the sheet, for example by applying so called Physical Vapour Deposition (PVD), by applying so called Chemical Vapour Deposition (CVD), by applying so called Atomic Layer Deposition (ALD) or by applying a Sputter coating technique etc.

Yet other techniques for the application of traces, strips, areas and the like, consisting of electronically conductive material 18 are not excluded according to the invention.

According to an alternative embodiment of a sheet 2 or device according to the invention, an electrical signal 8 is generated by at least one of the sensors 3 which is not directly supplied to the signal processing unit 9 via a connector 17, or in any case not by means of direct physical contact, but the transmission happens at least partly by means of a wireless connection, meaning by transmission of electromagnetic radiation.

In such a case, all the electrical signals 8 which are generated or influenced by the sensors 3 are preferably supplied to the signal processing unit 9 from a single connector 17 by means of a wireless connection.

It is obvious that such an embodiment provides many advantages given the measuring on the sheet 2, usually in the percussion instrument, and the processing of the measuring results in individual positions and even in positions moving in relation to each other can happen without being hindered by cabling or the like, allowing the user much more freedom of movement.

In yet another embodiment of a sheet 2 or device 1 according to the invention, the sensors 3 on the sheet 2 are fed by transducers which convert mechanical energy into electrical energy.

Such an embodiment allows a lot of autonomy to the sensors 3 and is even more suitable for an aforementioned application with a wireless connection, given the fact that no cabling is required for the electrical feed of the sensors 3.

A device 1 according to the invention, whether or not realized with a sheet 2 according to the invention as described before, can be used for all kinds of applications.

The signal processing unit 9 is preferably conceived in such a way that the electrical signals 8 supplied to the signal processing unit 9 are processed while creating an output in one or more of the following forms or a combination thereof:
the output is an electrical signal 11 as a function of the intensity of an impact on the sheet 2;
the output is an electrical signal 11 as a function of a change of intensity or a change of vibration frequency of the sheet 2;
the output is an electrical signal 11 as a function of the position of an impact on the sheet 2;
the output is a sound or signal as a function of a tension distribution or change in the tension distribution in the sheet 2;
the output is an indication concerning the tension distribution in the sheet 2 used for the tuning of the sheet 2; or,
the output is an indication concerning the amount of static tension in the sheet 2 used for the tuning of the sheet 2.

An interesting embodiment of a device 1 according to the invention has for example a signal processing unit 9 which generates an output that is suitable for sampling or modulation.

Yet another interesting embodiment of a device 1 according to the invention has for example a signal processing unit 9 which generates an output that is suitable to be linked to a database of a computer 14 in which sound fragments have been stored.

Naturally, many other applications are not excluded from the invention.

According to the invention, the electrical signals 8 generated or influenced by the sensors 3 preferably and directly or in combination, supply information about the condition of the sheet 2 in certain areas of the sheet 2 and the signal processing unit 9 is preferably provided with software or algorithms or the like for processing the electrical signals 8 in order to link the measurements by the sensors 3 to the physical characteristics in these specific zones of the sheet 2.

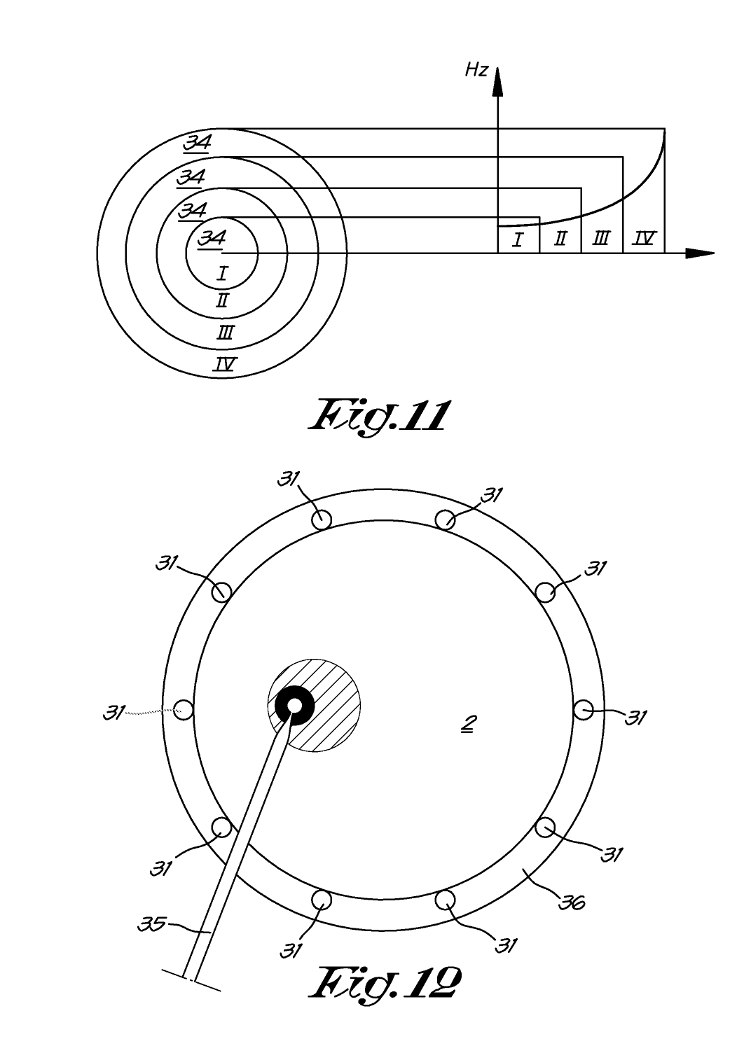

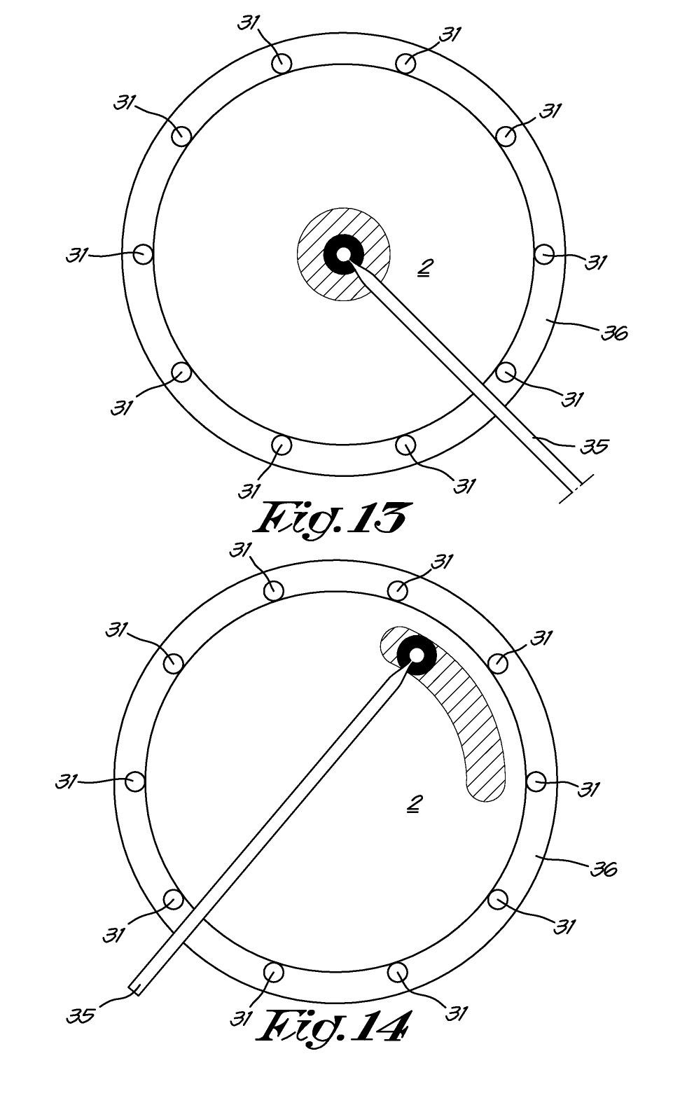

FIGS. 6 to 8 schematically represent a number of cases of a possible positioning of the sensors 3 in a drum head 2 which is stretched by means of tensioning bolts 31 to illustrate what the consequences are for the division of the drum head 2 in zones 32 in the form of circular sectors 32.

In each of these cases, ten sensors 3 are provided near the outer edge 16 of the sheet 2 on the lines AA′.

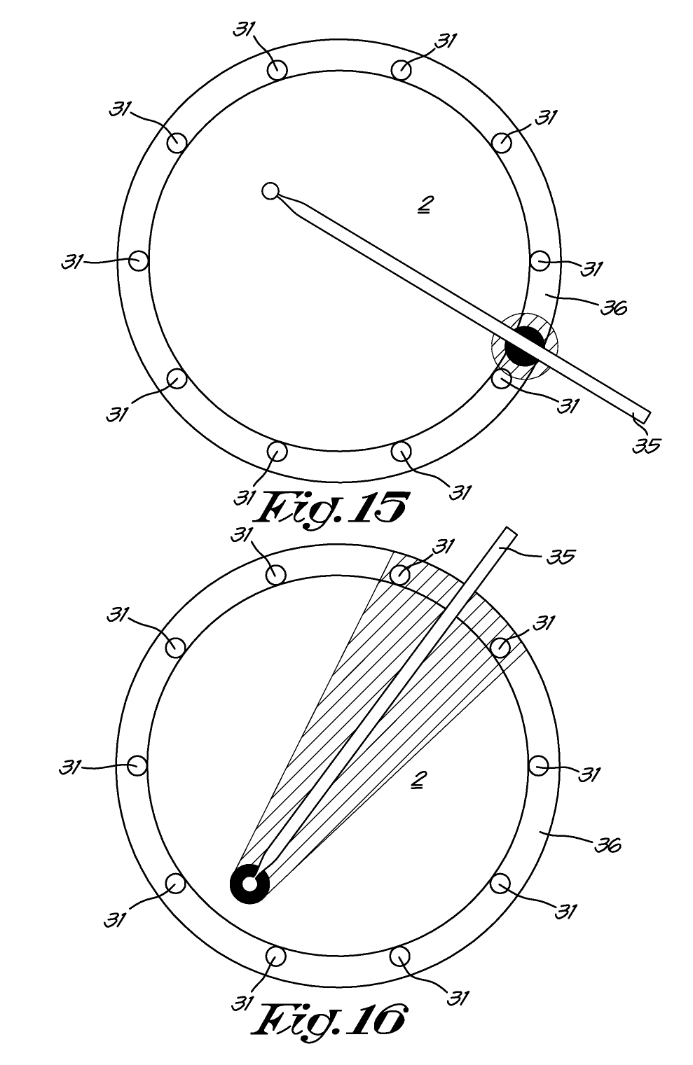

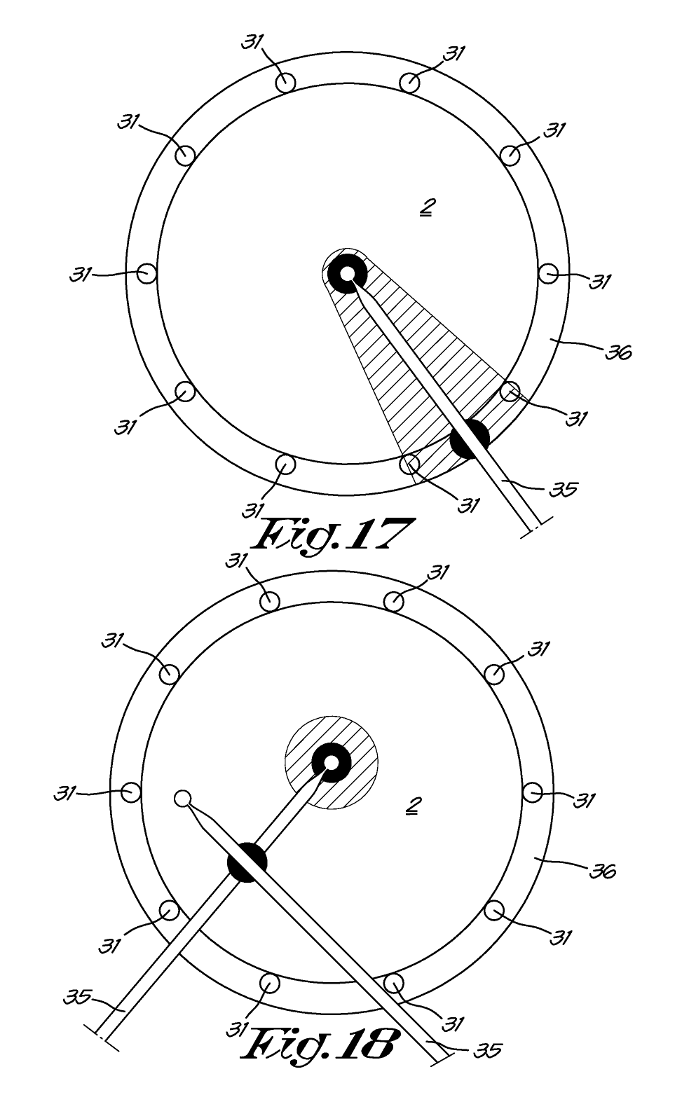

In FIG. 6 the sheet 2 is stretched by means of six tensioning bolts 31, while in FIGS. 7 and 8 respectively eight and ten bolts 31 were used.

A first application can be the use of the measurements supplied by the sensors 3 for the tuning of the sheet 2.

Measurement via the sensors 3 of the vibration frequency of the sheet 2 as well as a static capacity in the regarded position, allows the definition of the general tone produced by the sheet 2 when it is struck and it allows the indication of which of the tensioning bolts 31 needs to be tightened or loosened to obtain the right tone and an even tension in the sheet 2.

It is obvious that in the cases of FIGS. 6 and 7, measurements of several sensors 3 near the concerned tensioning bolt 31 need to be combined in order to obtain the information concerning certain tensioning bolts 31, for example by performing a mathematical interpolation, while this is not necessarily so in the case as represented in FIG. 8.

Furthermore, based on the different sensors 3, it is possible to define where the zone 32 is struck or where the zones 32 are struck in the sheet 2.

This kind of information can for example be linked to the sound recordings of other percussion instruments which are struck in the same way, via the signal processing unit 9.

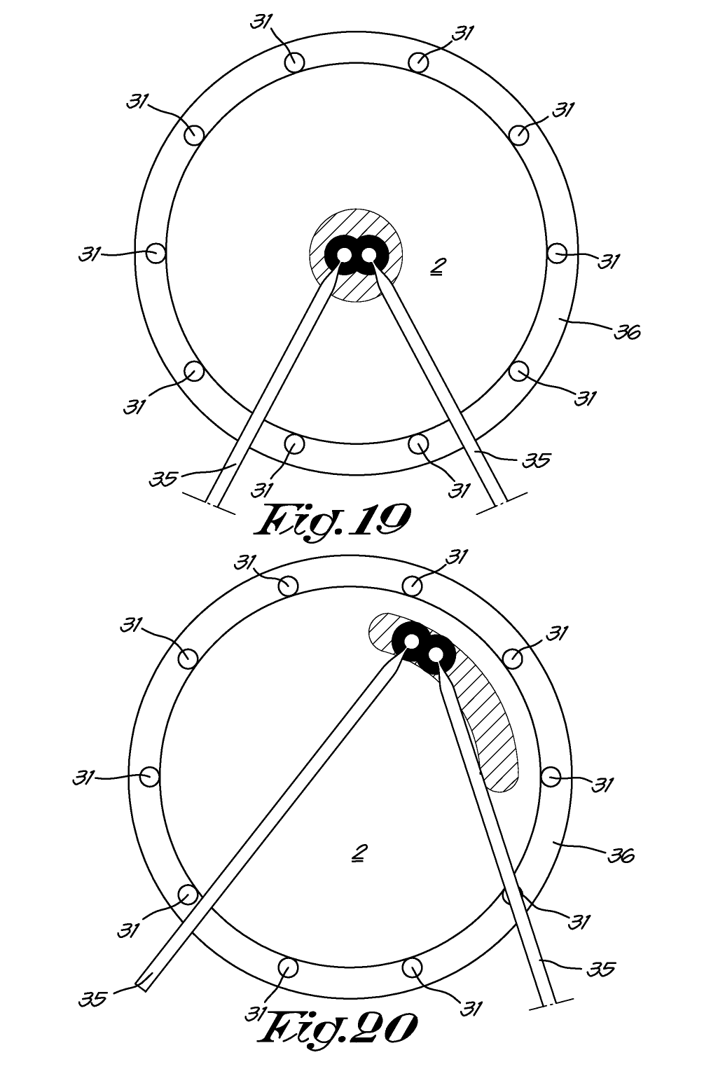

FIGS. 9 to 11 illustrate that more accurate fields 33 on a circular sheet 2 can be defined, given the fact that through a frequency measurement of the vibrating sheet 2 for example four concentric zones 34 also can be defined (see FIG. 11), which in combination with the ten zones 32 in the form of circle sectors, adds up to a total of forty fields 33, on which information can be supplied by measuring with the sensors 3.

It is obvious that in this way, a device 1 according to invention allows that a much more realistic image can be created of the status of the sheet 2, which, as suggested in the introduction, paves the way for many new applications.

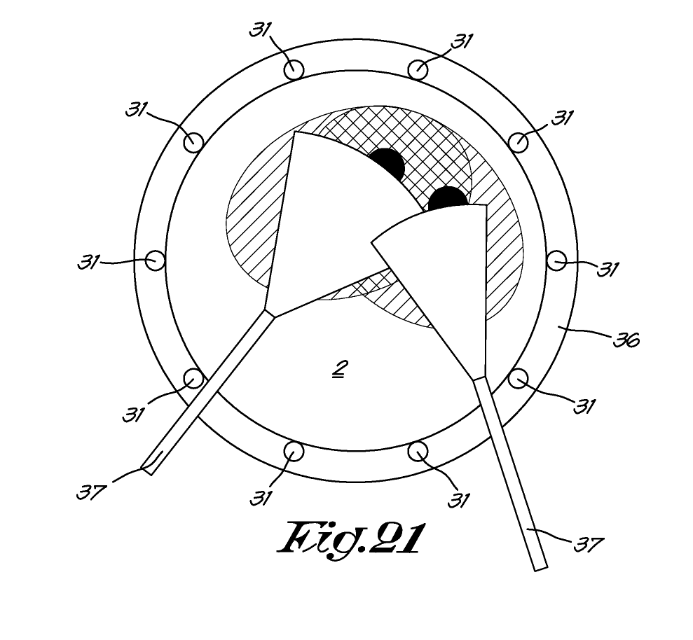

FIGS. 12 to 21 further illustrate a number of modes according to which a sheet 2 can be struck.

Following the above explanation, it can be concluded that a device 1 according to the invention allows the distinction of these different modes of striking, based on the signals 8 supplied by the sensors 3.

In the FIGS. 12 to 14, the sheet 2 is activated by striking it with a drum stick 35, respectively out of the center, in the center and near the outer edge of the sheet 2.

In the case of FIG. 12, a higher pitched tone is obtained compared to a strike on the sheet 2 in the center, whereby next to the keynote, also more overtones, the so called harmonics, are activated.

In the case in FIG. 13, a balanced tone is obtained, with fewer harmonics.

The case in FIG. 14 generates the highest pitched tone of the three striking modes according to FIGS. 12 to 14, whereby the harmonics are emphasized.

In FIGS. 15 to 17 a number of striking modes is represented whereby the rim 36 of the drum is activated whether or not in combination with an activation of the sheet 2 itself.

In FIG. 15, the drum stick 35 only activates this rim 36, producing a high pitched, dry tone with a clearly defined striking of the rim 36.

In the case as represented in FIG. 16, the tip of the drum stick 35 is resting on the sheet 2, while the rim 36 of the drum is struck with drum stick 35.

This produces a warm tone in combination with a woody click on the rim 36.

In FIG. 17, the sheet 2 is struck with the tip of drum stick 35, instead of resting on it like in the case of FIG. 16, while the rim 36 of the drum is also tapped by the drum stick 35.

This results in a sharp, high pitched sound.

In the case represented in FIG. 18, the sheet 2 is pressed with the tip of a first drum stick 35, while a second drum stick 35 taps the first drum stick 35.

The result is a high pitched tone, activating many harmonics.

FIG. 19 illustrates a roll with two drum sticks 35 in the center of the sheet 2, while FIG. 20 shows a similar roll with two drum sticks near the rim 36.

In the first case in FIG. 19, a balanced tone is produced, activating few harmonics, while in the case represented in FIG. 20, the result is a higher pitched tone with more emphasized harmonics.

Finally, FIG. 21 represents a situation in which the sheet 2 is activated by two drum brushes 37, whereby the first drum brush 37 is pressed against the sheet 2 and moves back and forth on the sheet 2, while the second drum brush 37 gently strikes the sheet 2.

The result is a dry, muffled sound, a whispered ruffle, whereby the sheet 2 is struck in a rather unpronounced manner.

The detection of the striking modes and possibly other modes by a device 1 according to the invention as described above, can for example be used in combination with a sheet 2 provided with a sheet layer (or ply) 22 with meshes, perforations, cutouts, apertures or holes 29, so that a drummer can hear a genuine drumming sound through a set of headphones without making too much ambient noise.

The present invention is by no means limited to the embodiments, described above as examples and illustrated in the figures, of a device 1 according to the invention for the measuring of physical characteristics or changes in physical characteristics in a sheet 2 and a sheet 2 which is adapted to the use of such a device 1 but such a device 1 and such a sheet 2 according to the invention can be realized in many forms and dimensions without abandoning the scope of the invention.

1. A sheet having applied thereto multiple sensors for measuring one or more physical characteristics of the sheet including a vibration frequency.

2. The sheet of claim 1 wherein the multiple sensors are applied to the sheet by printing or coating.

3. The sheet of claim 1 wherein at least one of the sensors is selected from the group consisting of resistive sensors; capacitive sensors; inductive sensors; and piezoelectric sensors.

4. The sheet of claim 1 wherein the one or more physical characteristics include a characteristic selected from the group consisting of a static tension distribution; a dynamic tension distribution; a change in tension; a position of a change in tension; a change in frequency; a position of a change in frequency; and combinations thereof.

5. The sheet of claim 1 wherein the sensors comprise a conducting material, optionally in combination with a dielectric and or a semiconducting material.

6. The sheet of claim 1 wherein the sensors are connected to one or more connectors by means of an electrically conductive material applied to the sheet in the form of at least one of a line, a strip or an area.

7. The sheet of claim 6 wherein the electrically conductive material is a metallic material or an electrically conductive organic polymer material.

8. The sheet of claim 1 which is circular, having an outer edge, and which has the sensors located at regular intervals on a circle near the outer edge.

9. The sheet of claim 1 which is at least partly provided with meshes, holes, cutouts, apertures or a net-shaped structure.

10. The sheet of claim 1 comprising multiple sheet layers or plies.

11. The sheet of claim 10 wherein at least one sheet layer is at least partly provided with meshes, holes, cutouts, apertures or a net-shaped structure.

12. The sheet of claim 1 wherein at least one sensor is printed or coated onto more than one side of the sheet.

13. The sheet of claim 10 wherein at least one sensor is printed or coated onto more than one side of the sheet or of a sheet layer or ply.

14. The sheet of claim 10 wherein the one or more physical characteristics include a characteristic selected from the group consisting of a static tension distribution; a dynamic tension distribution; a change in tension; a position of a change in tension; a change in frequency; a position of a change in frequency; and combinations thereof.

15. The sheet of claim 1 wherein the sensors are fed by transducers that convert mechanical energy to electrical energy.

16. The sheet of claim 9 wherein the sensors are fed by transducers that convert mechanical energy to electrical energy.

17. The sheet of claim 1 when used as a head of a percussion instrument.

18. The sheet of claim 9 when used as a head of a percussion instrument.

19. The sheet of claim 11 when used as a head of a percussion instrument.

20. A device comprising the sheet of claim 1 wherein the sensors generate or modify an electrical signal in response to the physical characteristic, said device further comprising a signal processing unit for processing the electrical signal.

21. A device comprising the sheet of claim 1 wherein the sensors generate or modify an electrical signal in response to the physical characteristic, said device further comprising a signal processing unit for processing the electrical signal.

22. The device of claim 21 wherein the electrical signal is supplied to the processing unit wholly or partly by wireless communication.

23. The device of claim 21 wherein the processing unit produces an output in a form selected from the group consisting of:
a signal in function of an intensity of an impact on the sheet;
a signal in function of a change in intensity of a vibration of the sheet;
a signal in function of a change in frequency of a vibration of the sheet;
a signal in function of a position of an impact on the sheet;
a signal in function of a tension distribution in the sheet;
a signal in function of a change in tension distribution in the sheet;
an indication concerning a tension distribution in the sheet for tuning the sheet;
an indication concerning a vibration frequency distribution in the sheet for tuning the sheet;
an indication concerning an amount of static tension in the sheet for tuning the sheet; and
combinations thereof.

24. A device comprising the sheet of claim 9 wherein the sensors generate or modify an electrical signal in response to the physical characteristic, said device further comprising a signal processing unit for processing the electrical signal.

25. The device of claim 24 wherein the processing unit produces an output in a form selected from the group consisting of:
a signal in function of an intensity of an impact on the sheet;
a signal in function of a change in intensity of a vibration of the sheet;
a signal in function of a change in frequency of a vibration of the sheet;
a signal in function of a position of an impact on the sheet;
a signal in function of a tension distribution in the sheet;
a signal in function of a change in tension distribution in the sheet;
an indication concerning a tension distribution in the sheet for tuning the sheet;
an indication concerning a vibration frequency distribution in the sheet for tuning the sheet;
an indication concerning an amount of static tension in the sheet for tuning the sheet; and
combinations thereof.

26. A device comprising the sheet of claim 10 wherein the sensors generate or modify an electrical signal in response to the physical characteristic, said device further comprising a signal processing unit for processing the electrical signal.

27. The device of claim 26 wherein the processing unit produces an output in a form selected from the group consisting of:
a signal in function of an intensity of an impact on the sheet;
a signal in function of a change in intensity of a vibration of the sheet;
a signal in function of a change in frequency of a vibration of the sheet;
a signal in function of a position of an impact on the sheet;
a signal in function of a tension distribution in the sheet;
a signal in function of a change in tension distribution in the sheet;
an indication concerning a tension distribution in the sheet for tuning the sheet;
an indication concerning a vibration frequency distribution in the sheet for tuning the sheet;
an indication concerning an amount of static tension in the sheet for tuning the sheet; and
combinations thereof.
